(19) United States
(12) Patent Application Publication
(10) Pub. No.: US 2013/0081820 A1
(43) Pub. Date: Apr. 4, 2013

(54) HOSTILE ENVIRONMENT STABLE COMPOSITIONS AND DRILLING AND FRACTURING FLUIDS CONTAINING SAME

(71) Applicants: Olusegun Matthew Falana, San Antonio, TX (US); Frank G. Zamora, Hollywood Park, TX (US); Daniel R. Dostie, Floresville, TX (US); Edward C. Marshall, Schwartz, TX (US); Sarkis R. Kakadjian, The Woodlands, TX (US)

(72) Inventors: Olusegun Matthew Falana, San Antonio, TX (US); Frank G. Zamora, Hollywood Park, TX (US); Daniel R. Dostie, Floresville, TX (US); Edward C. Marshall, Schwartz, TX (US); Sarkis R. Kakadjian, The Woodlands, TX (US)

(73) Assignee: CLEARWATER INTERNATIONAL, LLC, Houston, TX (US)

(21) Appl. No.: 13/249,819

(22) Filed: Sep. 30, 2011

(51) Int. Cl. E21B 43/26; E21B 43/00; C09K 8/584; E21B 7/00; C09K 8/38; C09K 8/62

(52) U.S. Cl. 166/308.1; 507/135; 507/256; 507/259; 175/57; 166/369

(57) ABSTRACT

Foam systems including a surfactant subsystem including one alpha-olefin sulfonic acid or a plurality of alkali metal alpha-olefin sulfonic acid salts and optionally, one ethoxylated alcohol sulfonate or a plurality of ethoxylated alcohol sulfonates, optionally, a pour point depressant subsystem including one glyme or a plurality of glymes and optionally, a corrosion inhibiting subsystem including one corrosion inhibitor or a plurality of corrosion inhibitors, where the system is thermally or heat stable up to 450° F., the system is environmentally benign, the system is capable of producing a foam in an aqueous medium including high amounts of crude oil, the system is efficient at low usage levels and the system is capable of reuse or at least on foam-defoam cycle. Methods for making and using including preparation of the foam systems, drilling, fracturing, completion and producing using the systems in conjunction with a gas.

### BACKGROUND OF THE INVENTION

1. Field of the Invention

Embodiments of the present invention relate to foam systems or compositions and methods for their use and preparation, where the systems have good thermal stability, are environmentally benign, are refoamable, are compatible with drilling fluids, drilling fluid additives, fracturing fluids and fracturing fluid additives and are affordable.

Embodiments of the present invention relate to foam systems or compositions and methods for their use and preparation, where the systems include have good thermal stability, are environmentally benign, are refoamable, are compatible with drilling fluids, drilling fluid additives, fracturing fluids and fracturing fluid additives and are affordable and are designed for hostile environments, where foam systems include a surfactant subsystem comprising one alpha-olefin sulfonic acid or a plurality of alkali metal alpha-olefin sulfonic acid salts.

2. Description of the Related Art

In prior art, there are a number of approaches to meeting demands in hostile environments. First, blend of products (e.g., surfactants) is employed. Second, increase in product usage to substitute degraded volume under use might be the only option. While in the former maintenance of balance in composition is a challenge, increased product consumption and hence economics of applying products under harsh conditions thus become prohibitive. Third, some products such as fluoro surfactants and silicones might be adopted but they are very costly or pose environmental concern.

There are few foam systems that have suitable properties at high temperatures, e.g., temperature ≧350° F. There are few foam systems that have suitable properties across different types of aqueous media such as fresh water, saline systems or other salt systems. There are few foam systems that have suitable properties when contaminated with crude in concentration of ≧30%, even as high a 50% crude. Current foam systems are expensive and not as recyclable as desired. Non-toxic, biodegradable foam system with wide applicability (temperature, salinity, contamination) are rare.

To date, there is paucity of fluid formulations that are thermally and saline stable as well as environmentally desirable. In oilfield, just as there is increasing global drilling activity and especially in hostile environments, environmental regulations are becoming ever more stringent. Therefore, there exist the need for affordable formulations that meet both performance and environmental requirements.

### SUMMARY OF THE INVENTION

Embodiments of the present invention provides aqueous foam systems including a surfactant subsystem comprising one alpha-olefin sulfonic acid or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels. The systems are also ideally suited for foamed fracturing fluids as they have high temperature stability up to 450° F. and are environmentally benign, robustness in their ability to foam in diverse aqueous media (e.g., aqueous media with up to 50% crude oil).

Embodiments of the present invention provides foamable drilling fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

Embodiments of the present invention provides foamable fracturing fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

Embodiments of the present invention provides foamable completion fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

Embodiments of the present invention methods for drilling a formation using foamable drilling fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

Embodiments of the present invention provides methods for fracturing using foamable fracturing fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

Embodiments of the present invention provides methods for completing a well using foamable completion fluids including an effective amount of an aqueous foam system including a surfactant subsystem comprising one alkali metal alpha-olefin sulfonic acid salt or a plurality of alkali metal alpha-olefin sulfonic acid salts, where the systems are designed for hostile environments. In certain embodiments, the systems also include a pour point depressant subsystem including one glyme or a plurality of glymes. In other embodiments, the systems including one ethoxylated alcohol sulfonate or a plurality of ethoxylated alcohol sulfonates. In other embodiments, the systems include a corrosion inhibiting subsystem including one corrosion inhibitor or a plurality of corrosion inhibitors. The systems are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels.

### DETAILED DESCRIPTION OF THE INVENTION

To the best of our understanding, novel surfactant systems with universal applicability in aqueous media have been developed for the first time. Unpredictably, the foam systems offer outstanding unique features compared to aqueous-based surfactants described in prior art. Specifically, the systems of this invention are thermally or heat stable up to 450° F.; are environmentally benign, robustness in their ability to foam in diverse aqueous media (e.g., aqueous media with up to 50% crude oil) and under several under-balanced drilling operation conditions, while retaining functionality for reuse, and are effective and efficient at low usage levels. Moreover, the systems of this invention are compatible with known drilling fluids and drilling fluid additives, are affordable, while positioning the advantageous characteristics disclosed herein.

We have now discovered foam systems capable of withstanding hostile environments of salinity, contamination and/or temperature. Embodiments of the foam systems are heat stable up to 450° F. Moreover, embodiments of the foam systems maybe formulated with novel environmentally friendly pour point depressants to permit handling at temperatures down to about −25° C. (−13° F.) or lower depending on the amount of pour point depressant used and on the exact system formulation. The present pour point depressants unlike nonyl phenol, which is a known toxicant, are environmentally friendly and biodegradable. The novel foam systems of this invention comprise one olefin or a plurality of olefins and one ethoxylated sulfonate or a plurality of ethoxylated sulfonates, optionally, the systems may include one oligomeric glyme pour point depressant or a plurality of oligomeric glyme pour point depressants.

The systems are capable of being taken through foam-defoam-refoam cycles, i.e., the systems are recyclable. The systems offer desirable foam properties under hostile conditions of high salinity, temperature, crude oil contamination (≦50%) and condensate (≦40%) and other contaminants at high contaminant levels. The systems are stable up to 450° F. and are compatible with drilling fluids and drilling fluid additives. The systems may be formulated with novel pour point reducers to meet requirements in extremely cold environments. The systems are economical, environmentally benign and are therefore more desirable than existing more costly foam systems.

We have discovered three separate embodiments of the foam systems of this invention that are capable of withstanding hostile environments such as salinity, oil contamination and temperature. Each embodiment is heat stable up to 450° F. Each embodiment may be formulated with a novel, environmentally friendly pour point depressant to permit handling at temperatures as low as −20° F. or lower. Additionally, each of the embodiment is environmentally friendly and biodegradable.

The foam systems of this invention are robust, stable in salt solution such as sea water and CaCl₂ solution; heat stable up to 450° F. in lab tests, are capable of withstanding up to 50% crude contamination and are suitable for single/multiple pass drilling operations. The foam systems of the present invention are less expensive than existing foam systems. The foam systems of the present invention are environmentally friendly including non-toxic, biodegradable alkyl sulfonates and novel non-toxic oligomeric glycol ethers employed as pour point depressant (unlike less depressing and/or toxic alcohols). The foam systems of the present invention are versatile and compatible with oilfield fluids and fluid additives commonly used in drilling, fracturing and stimulating. The foam systems of the present invention are useful in low concentrations and by the additional novel non-toxic oligomeric glycol ethers are well suited for cold temperature applications.

### Compositional Ranges and Properties

Embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 0 wt % to about 20 wt. % of an ethoxylated alcohol sulfonate or a mixture of ethoxylated alcohol sulfonates, and

from about 0 wt. % to about 20 wt. % of a glyme or mixture of glymes.

In other embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 0 wt % to about 15 wt. % of an ethoxylated alcohol sulfonate or a mixture of ethoxylated alcohol sulfonates, and

from about 0 wt. % to about 15 wt. % of a glyme or mixture of glymes.

In other embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 0 wt % to about 10 wt. % of an ethoxylated alcohol sulfonate or a mixture of ethoxylated alcohol sulfonates, and

from about 0 wt. % to about 10 wt. % of a glyme or mixture of glymes.

In other embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 1 wt % to about 20 wt. % of an ethoxylated alcohol sulfonate or a mixture of ethoxylated alcohol sulfonates, and

from about 1 wt. % to about 20 wt. % of a glyme or mixture of glymes.

In other embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 1 wt % to about 15 wt. % of an ethoxylated alcohol sulfonate or a mixture of ethoxylated alcohol sulfonates, and

from about 1 wt. % to about 15 wt. % of a glyme or mixture of glymes.

In other embodiments of the foam systems of this invention include:

from about 40 wt. % to about 60 wt. % of deionized water, and

from about 40 wt. % to about 60 wt. % of an alkali metal alpha-olefin sulfonic acid salt or mixtures of alkali metal alpha-olefin sulfonic acid salts,

from about 5 wt % to about 15 wt. % of an ethoxylated alcohol sulfonate or a mixture of ethoxylated alcohol sulfonates, and

from about 5 wt. % to about 15 wt. % of a glyme or mixture of glymes.

### Suitable Materials for Use in the Invention

### Alkali Metal Alpha-Olefin Sulfonic Acid Salts

Suitable alkali metal alpha-olefin sulfonic acid salts include, without limitation, alkali metal alpha-olefin sulfonic acid salts having between about 10 and 16 carbon atoms or mixtures or combinations thereof. In certain embodiments, the alkali metal alpha-olefin sulfonic acid salts have between about 10 and 14 carbon atoms or mixtures or combinations thereof. In other embodiments, the alkali metal alpha-olefin sulfonic acid salts have between about 12 and 14 carbon atoms or mixtures or combinations thereof. In other embodiments, the alkali metal alpha-olefin sulfonic acid salts have about 12 carbon atoms or mixtures or combinations thereof. In other embodiments, the alkali metal alpha-olefin sulfonic acid salts have about 14 carbon atoms or mixtures or combinations thereof. In all of these alkali metal alpha-olefin sulfonic acid salts, the alkali metal is selected from the group consisting of sodium (Na) and potassium (K). In certain embodiments, the alkali metal alpha-olefin sulfonic acid salts include Witconate AOS® surfactants available from Akzo Nobel. In other embodiments, the alkali meta alpha-olefin sulfonic acid salts include Witconate AOS® 12, a 12 carbon atom alkali metal alpha-olefin sulfonic acid salt and AOS® C₁₄-C₁₆ surfactants available from Akzo Nobel, a C₁₄-C₁₆ alkali metal alpha-olefin sulfonic acid salt.

### Ethoxylated Alcohol Sulfonates

Suitable ethoxylated alcohol sulfonates include, without limitation, ethoxylated alcohol sulfonates of the general formula CH₃(CH₂)ₓCH₂(OCH₂CH₂)ₙOSO₂M, where M is an alkali metal selected from the group consisting of sodium (Na), potassium (K) and mixtures or combinations thereof, x is an integer between about 3 and 12 and n is a integer between about 1 and 40. In certain embodiments, the ethoxylated alcohol sulfonates are of the general formula CH₃(CH₂)ₓCH₂(OCH₂CH₂)ₙOSO₂M, where M is an alkali metal selected from the group consisting of sodium (Na), potassium (K) and mixtures or combinations thereof, x is an integer between about 3 and 10 and n is a integer between about 1 and 30. In certain embodiments, the ethoxylated alcohol sulfonates are of the general formula CH₃(CH₂)ₓCH₂(OCH₂CH₂)ₙOSO₂M, where M is an alkali metal selected from the group consisting of sodium (Na), potassium (K) and mixtures or combinations thereof, x is an integer between about 3 and 8 and n is a integer between about 1 and 20. In certain embodiments, the ethoxylated alcohol sulfonates are of the general formula CH₃(CH₂)ₓCH₂(OCH₂CH₂)ₙOSO₂M, where M is an alkali metal selected from the group consisting of sodium (Na), potassium (K) and mixtures or combinations thereof, x is an integer having the value between 4 and 8, and n is a integer between about 1 and 20. In certain embodiments, the ethoxylated alcohol sulfonates is ALFONIC® 610-3.5, a ethoxylated alcohol sulfonates having formula CH₃(CH₂)ₓCH₂(OCH₂CH₂)ₙOH, where x varies between 4 and 8 and n varies between 1 and 20.

### Glymes

Suitable glymes for use in the systems of this invention includes, without limitation, ethylene glycol dimethyl ethers, propylene glycol dimethyl ethers, diethylene glycol dimethyl ethers, dipropylene glycol dimethyl ethers, polyethylene glycol dimethyl ethers of the general formula CH₃O(CH₂CH₂O)ₙCH₃, where n is an integer between about 3 and about 6, polypropylene glycol dimethyl ethers of the general formula CH₃O(CH₂C(CH₃)HO)ₙCH₃, where n is an integer between about 3 and about 6, poly(ethylene,propylene) glycol dimethyl ethers of the general formula CH₃O(CH₂CH₂O)ᵢ(CH₂C(CH₃)HO)ⱼCH₃, where i+j is an integer between about 3 and about 6, or mixtures or combinations of any of these glycol dimethyl ethers.

### Gases

Suitable gases for use in this invention include, without limitation, air, nitrogen, membrane nitrogen, other nitrogen/oxygen gas mixtures, carbon dioxide, an inert gas, methane, ethane, propane, butane, mixtures of methane, ethane, propane and butane, natural gas, exhaust gas, flue gas or other similar gases or mixtures or combinations thereof. Exemplary examples of inert gases including, without limitation, helium, neon, argon, xenon, krypton, or mixture or combinations thereof.

### Corrosion Inhibitors

Suitable corrosion inhibitor for use in this invention include, without limitation: amines, quaternary ammonium salts e.g., chloride, bromides, iodides, dimethylsulfates, diethylsulfates, nitrites, bicarbonates, carbonates, hydroxides, alkoxides, phosphates, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C₆ to C₂₄ synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Experiments of the Invention

### Foam Test

Foam test used a Lab Hamilton Beach Malt Mixer. The mix procedure was to mix the test drilling fluids at high speed for 45 seconds to 60 seconds and noting any change at 15 second intervals. Foaming concentrations that were tested are as set forth herein. After foaming on the mixer, the test drilling fluids were poured into either a 1,000 mL of 500 mL graduated cylinder to determine if the foam measurement were linear. The foam height represented the mL occupied by the foam after the foam was poured into the cylinder. The half life represents the time it takes a foam having an initial foam volume to decay by 50% of that original foam volume, e.g., if the initial foam volume is 500 mL as measured in a 1000 mL graduated cylinder, then the half life is the time is takes for the foam volume to reduce to a value of 250 mL.

The inventors have found that two compatible surfactants may be formulated into foam systems that meet performance requirements for use under hostile conditions. In Table 1, formulations are depicted corresponding to three embodiments of the foam systems of this invention having desirable properties for extreme, moderate and non-hostile environments. Not only are the foam systems of this invention tailored to meet performance benchmarks, but also, made to be more economical than existing foam systems, while have certain desirable and often superior performance characteristics.

TABLE 1
Raw Materials

| System 1 (Extreme) | System 2 (Moderate) | System (Basic) |
|---|---|---|
| AOS | AOS | AOS |
| Glyme¹ | Glyme¹ | Deionized Water |
| | Ethoxylated Hexyl | Ethoxylated Hexyl |
| | Sulfonate | Sulfonate |

¹Non-toxic oligomeric glycol ethers produced by Novolyte Technologies, USA.

### Preparation Method for a Basic Foam System, System 3

### Materials

Raw Materials and Amounts

| | Amount | Composition |
|---|---|---|
| Material | (lb) | (%) |
| Witconate AOS 12 | 0.50 | 50.00 |
| Deionized Water | 0.40 | 40.00 |
| 610, 3.5 Hexyl Sulfonate | 0.10 | 10.00 |
| Total | 1.00 | 100.00 |

### Procedure

The reactor was cleaned to a pristine condition. 0.5 lbs of Witconate AOS 12 were added to vessel through a feed line. The feed line was flushed with 60% of the 0.4 lbs of deionized water with minimal agitation to reduce foaming. The resulting solution was mixed slowly for 15 minutes. 0.10 lbs of ALFONIC®610-3.5 Hexyl Sulfonate were added to the reactor via the feed line. The fee line was flushed with the remaining 40% of the 0.40 lbs of deionized water. The resulting solution was mixed for 30 minutes. The final product has a pH neat between about 6.40 and about 7.40, a specific gravity between about 1.000 and about 1.100 and a color/appearance of amber/clear.

To prepare the formulations of System 1 and System 2, the pour point depressant was added before or after the addition of Witconate AOS 12 or the ALFONIC®610-3.5 Hexyl Sulfonate. The addition of the pour point depressant was performed with mixing with a mix after addition of 30 minutes.

### Performance Evaluation of Foam Systems of this Invention

The foam systems of this invention are quite robust and versatile. Thus, as stated above, the systems of this invention offer desirable properties at high temperatures. The inventors have not yet ascertained limitations to their functionality or foamability in aqueous media. Their resistance to contamination is outstanding; the systems remain functionality in presence of crude and condensate contaminants at concentrations up to 50% and 40%, respectively as shown in Table 2.

TABLE 2
Foam Properties of Foam System 1

| Conc. | | Foam Height | Half-Life |
|---|---|---|---|
| % | Fluid | (mL) | (min:sec) |
| 0.5 | Tap^{a} | 620 | 6:20 |
| 1.0 | Tap | 890 | 7:35 |
| 1.0 | 3% KCl | 800 | 7:00 |
| 1.0 | 1.75% SW^{b} | 830 | 7:00 |
| 1.0 | 3.5% SW | 730 | 6:30 |
| 1.0 | 3% HCOOK^{c} | 830 | 6:00 |
| 1.0 | 3% CaCl | 730 | 5:30 |
| 1.0 | 30% crude oil 36 API | 630 | 8:35 |
| 3.0 | 50% crude oil 36 API | 400 | 20:00 |
| 1.0 | Tap (after 16 h aging at 400° F.) | 740 | 6:00 |

^{a}Tap = Elmendorf TX USA tap water,
^{b}SW = sea water, and
^{c}HCOOK = potassium formate.

Apparently, Foam System 1 offers more excellent properties in saline conditions than in near fresh water as shown in Table 2. Like all the other formulations, it is recyclable, and suitable for single pass foam drilling operations. Similarly, all the formulations are compatible with the OmniBreak™ (available from Weatherford international) defoamer or alcohol based or similar alternate breaker systems.

TABLE 3
Foam Properties of Foam System 2

| | | | Foam | | Pour |
|---|---|---|---|---|---|
| Conc. | | | Height | Half-Life | Point |
| % | Fluid | | (mL) | (min:sec) | (° F.) |
| 0.5 | 3% | KCL | 730 | 6:20 | −25° C. |
| 0.5 | 1.75% | SW | 760 | 6:30 | |
| 0.5 | 3.5% | SW | 780 | 6:40 | |
| 2.0 | 50% | Crude Oil 36 API | 400 | 20:00 | |

↓30% Diluted Foam System 2

| 0.5 | Tap | | 760 | 6:20 | −18° C. |
|---|---|---|---|---|---|
| 0.5 | 3% | KCL | 600 | 5:40 | |
| 0.5 | 1.75% | SW | 650 | 5:00 | |
| 0.5 | 3.5% | SW | 630 | 4:35 | |
| 1.0 | Tap | | 880 | 6:50 | |
| 1.0 | 3% | KCL | 850 | 6:35 | |
| 1.0 | 1.75% | SW | 840 | 6:40 | |
| 1.0 | 3.5% | SW | 830 | 6:10 | |
| 1.0 | 10% | Condensate | 550 | 5:15 | |
| 1.0 | 30% | Condensate | 420 | 3:00 | |
| 1.0 | 20% | Rev Dust | 870 | 8:00 | |
| 1.0 | Tap/KleanVis H¹ @ 0.25% | | 730 | 14:30 | |
| 1.0 | 10% | Crude Oil, 36 API | 830 | 7:30 | |
| 1.0 | 30% | Crude Oil, 36 API | 630 | 8:30 | |
| 2.0 | 50% | Crude Oil 36 API | 300 | 20:00 | |

| | | | |
|---|---|---|---|
| 1.0 | Tap (after16 h aging @ 400° F.) | 850 | 6:00 |

¹KleanVis H a biopolymer available from Weatherford International.

Though Foam System 2 can readily be diluted to 30% of its original formulation with desirable properties, it offers similar foam properties to Foam System 1 under same test conditions. However, the system is specifically formulated to retain pourability up to −25° C. More importantly, all the systems are tolerant to solids contamination (e.g., Rev Dust) and compatible with commonly used bio-based polymers. An example is shown in Table 3, where KleanVis H (available from Weatherford International) was employed to increase foam cleaning capacity by increasing half-life or foam thickness.

### Comparison of Foam System 1 with Known Foam Systems

Three commonly used foamers; KleanFoam™, FMA™100 and DuraFoam™ (all available from Weatherford International) were evaluated against OmniFoam™ in various aqueous media. The result is tabularized in Table 4.

TABLE 4
Comparison of Foam Properties of Foams System 1 and
Some Commercially Available Foam System¹

| | | | | Foam | |
|---|---|---|---|---|---|
| | Conc. | | | Height | Half-Life |
| Foamer | (%) | Medium | | (mL) | (min:sec) |
| | 0.5 | Tap | | 750 | 5:30 |
| KleanFoam ™ | 0.5 | 3% | KCL | 780 | 5:00 |
| | 0.5 | 1.75% | SW | 800 | 5:30 |
| | 0.5 | 3.5% | SW | 800 | 5:15 |
| | 0.5 | Tap | | 800 | 5:00 |
| FMA ™100 | 0.5 | 3% | KCL | 820 | 4:30 |
| | 0.5 | 1.75% | SW | 800 | 4:20 |
| | 0.5 | 3.5% | SW | 800 | 5:20 |
| | 0.5 | Tap | | 540 | 11:00 |
| DuraFoam ™ | 0.5 | 3% | KCL | 620 | 5:30 |
| | 0.5 | 1.75% | SW | 580 | 15:00 |
| | 0.5 | 3.5% | SW | 530 | 11:00 |
| | 0.5 | Tap | | 830 | 6:00 |
| Foam System 1 | 0.5 | 3% | KCL | 710 | 6:00 |
| | 0.5 | 1.75% | SW | 700 | 5:10 |
| | 0.5 | 3.5% | SW | 680 | 5:10 |

Whereas, KleanFoam™ and Foam System 1 are both recyclable, while FMA™ 100 and DuraFoam™ are not, only Foam System 1 offers desirable foam properties in fluids with more than 30% crude contamination. Yet, it is the cheapest fluid system compared to the others. Equally noteworthy is the environmentally friendliness of the foam system of this invention more than any of the other foam systems presented in Table 4.

Foam System 1 was also corrosion tested by placing coupons in contact with fluids including different amounts of Foam System 1, OmniBreak™, and CorrFoam™.

TABLE 5
Corrosion Testing of Foam System 1 with Standard Carbon Steel

| | | | | | | Time | D |
|---|---|---|---|---|---|---|---|
| Cell # | Coupon # | Solution | iWt | fWt | WtL | (Days) | (g/cm³) |
| 1 | 184 | Tap + 2% Foam System 1 + | 22.3204 | 21.8733 | 0.4471 | 2 | 7.78 |
| | | 2% OmniBreak | | | | | |
| 2 | 185 | Tap + 2% Foam System 1 + | 22.3139 | 22.3019 | 0.0120 | 2 | 7.87 |
| | | 2% OmniBreak ™ + | | | | | |
| | | 0.5% CF1^{a}, pH 10, KOH | | | | | |
| 3 | 186 | 3.5% SW + 2% Foam System 1 + | 22.3443 | 22.1724 | 0.1719 | 2 | 7.87 |
| | | 2% OmniBreak ™ + | | | | | |
| | | 0.5% CF1^{a}, pH 10, KOH | | | | | |
| 4 | 187 | 3.5% SW + 2% Foam System 1 + | 22.3811 | 22.3040 | 0.0771 | 1 | 7.87 |
| | | 2% OmniBreak ™ | | | | | |
| 5 | 188 | 3.5% SW + 2% Foam System 1 + | 21.6535 | 21.6410 | 0.0125 | 1 | 7.87 |
| | | 2% OmniBreak ™ + | | | | | |
| | | 0.2% CF1^{a} | | | | | |
| 6 | 189 | 3.5% SW + 2% Foam System 1 + | 22.4371 | 22.4133 | 0.0238 | 1 | 7.87 |
| | | 2% OmniBreak ™ + | | | | | |
| | | 0.5% CF1^{a} | | | | | |
| 7 | 190 | 3.5% SW + 2% Foam System 1 + | 22.1818 | 22.1682 | 0.0136 | 1 | 7.87 |
| | | 2% OmniBreak ™ + | | | | | |
| | | 0.2% CF1^{a}, pH 10, KOH | | | | | |

| | | | SA | Corr | Corr | |
|---|---|---|---|---|---|---|
| Cell # | Coupon # | Solution | (in²) | (MPY) | (lb/ft²/yr) | Pitting |
| 1 | 184 | Tap + 2% Foam System 1 + | 3.467 | 182.7 | 7.43 | heavy |
| | | 2% OmniBreak ™ | | | | |
| 2 | 185 | Tap + 2% Foam System 1 + | 3.467 | 4.9 | 0.20 | slight |
| | | 2% OmniBreak ™ + | | | | |
| | | 0.5% CF1^{a}, pH 10, KOH | | | | |
| 3 | 186 | 3.5% SW + 2% Foam System 1 + | 3.467 | 70.2 | 2.86 | heavy |
| | | 2% OmniBreak ™ + | | | | |
| | | 0.5% CF1^{a}, pH 10, KOH | | | | |
| 4 | 187 | 3.5% SW + 2% Foam System 1 + | 3.467 | 63.0 | 2.56 | medium |
| | | 2% OmniBreak ™ | | | | |
| 5 | 188 | 3.5% SW + 2% Foam System 1 + | 3.467 | 10.2 | 0.42 | slight |
| | | 2% OmniBreak ™ + | | | | |
| | | 0.2% CF1^{a} | | | | |
| 6 | 189 | 3.5% SW + 2% Foam System 1 + | 3.467 | 19.5 | 0.79 | none |
| | | 2% OmniBreak ™ + | | | | |
| | | 0.5% CF1^{a} | | | | |
| 7 | 190 | 3.5% SW + 2% Foam System 1 + | 3.467 | 11.1 | 0.45 | slight |
| | | 2% OmniBreak ™ + | | | | |
| | | 0.2% CF1^{a}, pH 10, KOH | | | | |

^{a}CF1 = CORRFOAM 1 available from Weatherford international

The data showed that corrosion is satisfactorily manageable under a worst case scenario of using carbon steel alloy with CorrFoam™ 1 as the corrosion inhibitor. CorrFoam™ 1 is a phosphate ester based inhibitor available from Weatherford International.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. An aqueous foam system comprising:
a surfactant subsystem including:
one alpha-olefin sulfonic acid salt or a plurality of alkali metal alpha-olefin sulfonic acid salts, and
optionally, one ethoxylated alcohol sulfonate or a plurality of ethoxylated alcohol sulfonates,
optionally, a pour point depressant subsystem including one glyme or a plurality of glymes,
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is suitable for foam drilling, foam fracturing and foam completion operations.

2. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 20 wt. % of an ethoxylated alcohol sulfonate or a mixture of ethoxylated alcohol sulfonates, and
wherein the pour point depressant subsystem includes:
from about 0 wt. % to about 20 wt. % of a glyme or mixture of glymes.

3. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 15 wt. % of an ethoxylated alcohol sulfonate or a mixture of ethoxylated alcohol sulfonates, and
wherein the pour point depressant subsystem includes:
from about 0 wt. % to about 15 wt. % of a glyme or mixture of glymes.

4. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 10 wt. % of an ethoxylated alcohol sulfonate or a mixture of ethoxylated alcohol sulfonates, and
wherein the pour point depressant subsystem includes:
from about 0 wt. % to about 10 wt. % of a glyme or mixture of glymes.

5. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 1 wt % to about 20 wt. % of an ethoxylated alcohol sulfonate or a mixture of ethoxylated alcohol sulfonates, and
wherein the pour point depressant subsystem includes:
from about 1 wt. % to about 20 wt. % of a glyme or mixture of glymes.

6. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 1 wt % to about 15 wt. % of an ethoxylated alcohol sulfonate or a mixture of ethoxylated alcohol sulfonates, and
wherein the pour point depressant subsystem includes:
from about 1 wt. % to about 15 wt. % of a glyme or mixture of glymes.

7. The system of claim 1, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 5 wt % to about 15 wt. % of an ethoxylated alcohol sulfonate or a mixture of ethoxylated alcohol sulfonates, and
wherein the pour point depressant subsystem includes:
from about 5 wt. % to about 15 wt. % of a glyme or mixture of glymes.

8. A foamable drilling fluid comprising:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or at least on foam-defoam cycle, and
where the fluid is suited for under-balanced or managed pressure drilling.

9. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 20 wt. % of an ethoxylated alcohol sulfonate or a mixture of ethoxylated alcohol sulfonates, and
wherein the pour point depressant subsystem includes:
from about 0 wt. % to about 20 wt. % of a glyme or mixture of glymes.

10. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 15 wt. % of an ethoxylated alcohol sulfonate or a mixture of ethoxylated alcohol sulfonates, and
wherein the pour point depressant subsystem includes:
from about 0 wt. % to about 15 wt. % of a glyme or mixture of glymes.

11. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 0 wt % to about 10 wt. % of an ethoxylated alcohol sulfonate or a mixture of ethoxylated alcohol sulfonates, and
wherein the pour point depressant subsystem includes:
from about 0 wt. % to about 10 wt. % of a glyme or mixture of glymes.

12. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 1 wt % to about 20 wt. % of an ethoxylated alcohol sulfonate or a mixture of ethoxylated alcohol sulfonates, and
wherein the pour point depressant subsystem includes:
from about 1 wt. % to about 20 wt. % of a glyme or mixture of glymes.

13. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 1 wt % to about 15 wt. % of an ethoxylated alcohol sulfonate or a mixture of ethoxylated alcohol sulfonates, and
wherein the pour point depressant subsystem includes:
from about 1 wt. % to about 15 wt. % of a glyme or mixture of glymes.

14. The fluid of claim 8, wherein the surfactant subsystem includes:
from about 40 wt. % to about 60 wt. % of deionized water, and
from about 40 wt. % to about 60 wt. % of an alkali metal alpha-olefin sulfonic acid salt or mixtures of alkali metal alpha-olefin sulfonic acid salts,
from about 5 wt % to about 15 wt. % of an ethoxylated alcohol sulfonate or a mixture of ethoxylated alcohol sulfonates, and
wherein the pour point depressant subsystem includes:
from about 5 wt. % to about 15 wt. % of a glyme or mixture of glymes.

15. A methods for drilling a formation comprising:
drilling into a formation, while circulating a foamable drilling fluid comprising:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or is capable of undergoing at least on foam-defoam cycle, and injecting a gas into the drilling fluid at or near the distal end of a drill bit of a drill string at a rate sufficient to convert the foamable drilling fluid into a foam.

16. A foamable fracturing fluid comprising:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or is capable of undergoing at least on foam-defoam cycle.

17. A methods for fracturing using a foamable fracturing fluid comprising:
injecting a fracturing fluid and a gas into a formation under conditions to result in fracturing the formation, where the fluid comprises:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or is capable of undergoing at least on foam-defoam cycle.

18. A foamable production fluid comprising:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or is capable of undergoing at least on foam-defoam cycle.

19. A methods for producing a well using foamable fluid comprising:
injecting into a producing formation a foamable fluid and sufficient gas to produce a foam having a desired density, where the fluid comprises:
an effective amount of an aqueous foam system including:
a surfactant subsystem comprising:
one alkali metal alpha-olefin sulfonic acid salt or a plurality of alkali metal alpha-olefin sulfonic acid salts and
optionally, one ethoxylated alcohol sulfonate or a plurality of ethoxylated alcohol sulfonates,
optionally, a pour point depressant subsystem including one glyme or a plurality of glymes;
optionally, a corrosion inhibiting subsystem including one corrosion inhibitor or a plurality of corrosion inhibitors,
where the system is thermally or heat stable up to 450° F., the system is environmentally benign, the system is capable of producing a foam in an aqueous medium including high amounts of crude oil, the system is efficient at low usage levels and the system is capable of reuse or is capable of undergoing at least on foam-defoam cycle.
